(19) United States
(12) Patent Application Publication
(10) Pub. No.: US 2006/0010269 A1
(43) Pub. Date: Jan. 12, 2006

(54) Multiple stream readout

(76) Inventor: Godert Willem Renswoud Leibbrandt, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/528,936

(22) PCT Filed: Sep. 18, 2003
(86) PCT No.: PCT/IB03/04101

§ 371 Date: Mar. 23, 2005

(30) Foreign Application Priority Data
Sep. 26, 2002 (EP) 02079055.6

(51) Int. Cl. G06F 13/12

(52) U.S. Cl. 710/74

(57) ABSTRACT

An apparatus and a method for streaming real time data from a storage medium containing layered coding formats is proposed. The method comprises the steps receiving from one or more applications commands initiating at least two data streams and indicating a demanded resolution, retrieving information regarding coding formats available on said storage medium and regarding maximum read-out data rate supported by a data readout device, selecting a compression format for each data stream on the basis of said received commands, and said retrieved coding format information, so that the sum of data streams does not exceed said maximum read-out data rate, and sending streaming requests corresponding to said selected compression formats to said data readout device.

The invention relates to an apparatus and a method for streaming real time data from a storage medium containing layered coding formats, and more particular to a multiple stream readout apparatus and method for optical discs.

Because of the massive amounts of data inherent in digital video, the transmission of full-motion, high-definition digital video signals is a significant problem in the development of high-definition television. More particularly, each digital image frame is a still image formed from an array of pixels according to the display resolution of a particular system. As a result, the amounts of raw digital information included in high resolution video sequences are massive. In order to reduce the amount of data that must be sent, compression schemes are used to compress the data. Various video compression standards or processes have been established and still are under progression, such as MPEG-2, MPEG-4, H.263, H.264, etc.

Methods for making a video available at various resolutions and/or qualities in one stream have been developed. They are loosely referred to as scalability techniques. There are three axes on which one can deploy scalability. The first is scalability on the time axis, often referred to as temporal scalability. Secondly, there is scalability on the quality axis, often referred to as signal-to-noise scalability or fine-grain scalability. The third axis is the resolution axis (number of pixels in image) often referred to as spatial scalability, layered coding, or layered compression. In layered coding, the bit-stream is divided into two or more bit-streams, or layers. Each layer can be combined to form a single high quality signal. For example, a base layer may provide a lower quality video signal, while an enhancement layer provides additional information that can enhance the base layer image.

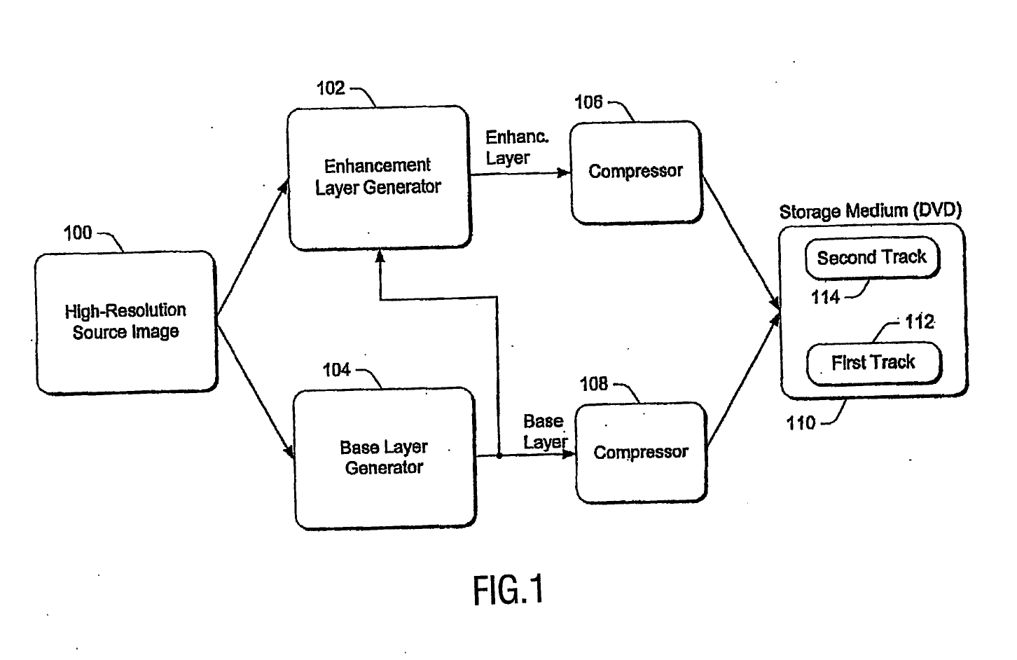

FIG. 1 illustrates a known layered encoding system that separates a high-resolution source image into a base layer and an enhancement layer, and stores the base layer and the enhancement layer in separate tracks on a storage medium, such as a DVD. A layered encoding system may also be referred to as an image encoding system. A high-resolution source image 100 is captured using a video camera or other device capable of capturing an image. A series of successive source images are captured to generate a video program (e.g., a television program or a movie).

The high-resolution source image 100 is communicated to an enhancement layer generator 102 and a base layer generator 104. The enhancement layer generator 102 generates an enhancement layer portion of the source image 100 and communicates the enhancement layer to a compressor 106. The enhancement layer generator 102 generates the enhancement layer by comparing the base layer data (received from the base layer generator 104) to the high-resolution source image data. For example, the enhancement layer generator 102 subtracts the base layer data from the high-resolution source image data, thereby leaving only the high-resolution portions of the image (i.e., the enhancement layer).

The base layer generator 104 generates a base layer portion of the source image 100 and communicates the base layer to a compressor 108. The compressor 106 generates a compressed version of the enhancement layer data and the compressor 108 generates a compressed version of the base layer data. In a particular embodiment of the invention, compressor 108 compresses the base layer data using, for example, the MPEG-2 (moving picture experts group) compression algorithm. Similarly, compressor 106 may compress the enhancement layer using the MPEG-2 compression algorithm. However, compressor 106 is not required to use the same compression algorithm as compressor 108. For example, compressor 106 may use a compression algorithm that utilizes three-dimensional wavelets to compress the enhancement layer information, or the like.

The compressed base layer is stored on a first data storage track 112 of storage medium 110. A data storage track is a collection of multiple sectors on a storage medium that can be read in sequence in real time. For example, a data storage track on an optical disc may be a continuous series of data elements stored in a generally circular pattern that are read as the disc rotates. Alternatively, a data storage track on a disc may store two interleaved streams of data, such as enhancement layer data interleaved with base layer data, in multiple sectors scattered over the disc.

The compressed enhancement layer is stored on a second data storage track 114 of storage medium 110. In this example, storage medium 110 is a DVD. The first and second data storage tracks 112 and 114 may be located on the same physical layer of the DVD or may be located on different physical layers of the DVD (a DVD can have two sides with two physical layers on each side).

Compressors 106 and 108 compress the enhancement layer and base layer data to reduce the storage space required to store the data. If the enhancement layer and/or the base layer do not require compression (i.e., the storage medium 110 has sufficient storage space without compressing the data), then compressor 106 and/or 108 can be eliminated from the system shown in FIG. 1.

A layered coding format produced in the manner described above can provide compatibility between different video standards or decoder capabilities. With layered coding, the base layer video may have a lower resolution than the input video sequence, in which case the enhancement layer carries information which can restore the resolution of the base layer to the input sequence level.

Various applications are known and will become more important in future, simultaneously demanding for multiple data streams. These are for example:

Picture in picture (PIP) applications in which a second video/picture is shown in a small window partially overlaying a first video/picture shown in a full screen format. These applications, for example, can allow for viewing the same scene shot from a different angle, or a video of the director giving his comments, simultaneously.

Split screen mode, wherein a plurality of videos is shown simultaneously on predetermined adjacent regions of the screen.

Overlay mode, wherein for example an interactive application is overlaid on a primary movie.

The DVD format, for example, supports multiple camera angles (or video angles). A viewer of the program stored on a DVD may select the default camera angle or one of several alternate camera angles. Although DVD technology supports multiple camera angles, programs are not necessarily recorded using multiple camera angles. Due to the added cost of recording a video program using multiple camera angles, many programs do not utilize the DVD tracks provided for the alternate camera angles.

However, all known storage media do only have limited read out bandwidth. In BD-ROM for example, the supported maximum read-out data rate, which had not been fixed yet in a specification, is expected to be chosen at 54 Mbit/s at single speed read out. The reasons for such relatively low read out rates, in general, are cost factors (cheaper components) and power considerations for portable systems. On the other hand, the video stream, which is of high definition quality, is expected to have a bit rate of up to 40 Mbit/s. Therefore, if one or more applications demand for a data stream at the maximum read-out data rate, simultaneous readout of more than 1 video stream obviously cannot be supported. More general, a recording medium has a maximum read-out data rate (Y) and contains streaming data to be read at a streaming bit rate (X), whereby, the condition X<Y has to be fulfilled. However, multiple (n) streams may be require to be read out simultaneously, which requirement can not be fulfilled for nX>Y.

The object of the present invention therefore is to provide a apparatus and a method for streaming real time data from a storage medium which overcomes the above limitation.

According to a first aspect of the present invention this object is achieved by an apparatus as described in the opening paragraph comprising a selection means and a data readout device, the selection means being arranged to receive from one or more applications commands initiating at least two data streams and indicating a demanded resolution, to retrieve information regarding coding formats available on said storage medium and regarding maximum read-out data rate supported by the data readout device, to select a compression format for each data stream on the basis of said received initiating commands, and said retrieved coding format information, so that the sum of data streams does not exceed said maximum read-out data rate, and to send a streaming request corresponding to said selected compression formats; and the data readout device being arranged to receive said streaming request from said selection means, to read out data from said storage medium and to output corresponding data streams according to said request.

According to a second aspect of the invention which constitutes a further development of the first aspect said selection means is arranged to access a predetermined priority information of said applications and selects said compression format according to said predetermined priority information.

According to a third aspect of the invention which constitutes a further development of the first aspect said selection means is arranged to interpret a tag carried by each of said initiating commands indicating a level of priority and selects said compression format according to said level of priority.

According to a fourth aspect of the invention which constitutes a further development of anyone of the first to third aspects said selection means is arranged to check available system resources and to select said compression format further taking into account said system resources.

According to a fifth aspect of the invention which constitutes a further development of anyone of the first to fourth aspects said selection means comprises means arranged to reduce said maximum read out data rate by a value taking into account a processing time said data readout device requires for switching between the accesses to said at least two data streams, and to provide the result for said selection.

According to a sixth aspect of the invention the above object is further achieved by a method as described in the opening paragraph comprising the steps: receiving from one or more applications commands initiating at least two data streams and indicating a demanded resolution, retrieving information regarding coding formats available on said storage medium and regarding maximum read-out data rate supported by a data readout device, selecting a compression format for each data stream on the basis of said received commands, and said retrieved coding format information, so that the sum of data streams does not exceed said maximum read-out data rate, and sending streaming requests corresponding to said selected compression formats to said data readout device.

According to a seventh aspect of the invention which constitutes a further development of the sixth aspect said selection is executed according to a predetermined priority of said applications.

According to an eighth aspect of the invention which constitutes a further development of the sixth aspect each of said initiating commands carries a tag indicating a level of priority and said selection is executed according to said level of priority indicated by said tag.

According to a ninth aspect of the invention which constitutes a further development of anyone of the sixth to eighth aspects the method comprises the step checking available system resources and said selection further takes into account said system resources.

According to a tenth aspect of the invention which constitutes a further development of anyone of the sixth to ninth aspects the method comprises the steps reducing said maximum read out data rate by a value taking into account a processing time said data readout device requires for switching between the accesses to said at least two data streams, and providing the result for said selection.

Each command should directly or indirectly indicate a demanded quality or resolution which corresponds to an assigned data stream X. For example, the command may include a tag indicating from which application the command was received. This information then, for example, may be translated as follows:

Full screen display equals high quality (e.g. HD at a max bit rate of X_{HD}=40 Mbit/s),

Picture-in-picture equals low quality (e.g. CIF at a max bit rate of X_{CIF}=4 Mbit/s, and an average bit rate of 1-2 Mbit/s),

Mosaic of many streams equals low quality,

Split screen equals medium quality (e.g. Standard quality at a max bit rate of X_{med}=10 Mbit/s, and an average bit rate of 4.5 Mbit/s), or

Overlay mode equals low quality.

In many cases the straight addition of the requested data streams may already be sufficient to get the sum below the maximum read out data rate Y. Assuming the above bit rates, for example, during normal video play back of a single stream (first application), the highest quality is viewed at X_{HD}=(max) 40 Mbit/s by, for instance, reading the base layer and the enhancement layer of the disc. If a second application is started, e.g. a picture in picture application, this would require access to a second stream at X_{CIF}=(max) 4 Mbit/s by, for instance, only reading the base layer of the disc. The sum of both streams does not exceed 44 Mbit/s. A 1× BD-ROM-drive providing data at Y=54 Mbit/s, hence, would be an appropriate read-out device. In this case the selection means finds that the sum of the demanded data streams does not exceed Y and, therefore, simply has to select compression formats corresponding to the originally demanded resolution.

In this regard it is to be noted, that a processing time (overhead) due to (mechanical) switching or jumping between different locations on the storage medium where the data requested for the one or more applications are stored reduces the available maximum read out data rate to an effective value Y_{eff}<Y. This will be taken into account by automatically reducing said maximum read out data rate. For example, a fixed value for each accessed stream, i.e. for each application, can be subtracted. The so corrected read out data rate Y_{corr}≦Y_{eff} then is the decisive (limiting) factor for the selection of the appropriate compression formats.

For those situations, in which the sum of data streams is higher than Y there is a genuine competition of requests. The apparatus, therefore, has to make a decision which request(s) to serve with a lower data rate and hence lower quality/resolution than demanded. One option is to make a random choice. Preferably, an order of choice is provided. According to the second and sixth aspect of the invention, respectively, for this purpose a predetermined priority information is proposed. This priority information may be associated with the tag indicating from which application the command was received. It can be stored in a look up table or the like being part of the apparatus. The selection means accesses this information by simply inputting the tag value. In the more sophisticated embodiment according to the third and seventh aspect of the invention, respectively, each initiating command may carry a tag directly indicating a level of priority. This has the advantage that the priority can be adopted to specific demands rather than being assigned to an application in a predetermined manner.

For example, the full screen display application may indicate (or may be predetermined) to have the highest priority so that its quality should be sacrificed last while the PIP application or the overlay mode application may indicate (or may be predetermined) to have the lowest priority causing the selection means to decrease the resolution of this applications first. Both, the predetermined priority information and the indicated level of priority are also applicable to split screen mode applications. In this case, two or more applications may indicate (or may be predetermined) to have the same priority which causes the selection means to reduce its resolutions equally.

The bit-rate of one or more video stream(s) can be adjusted dynamically dependent on the instantaneous use of disc resources by the applications because the apparatus selects an appropriate compression format/resolution automatically. By this means, the image quality always can be provided at the highest level possible. A loss of image quality will be restricted temporarily to situations of high traffic, i.e. when nX>Y.

If a video is played back to a screen having a resolution equal or lower than supported by a certain layer (e.g. by the base layer or by one of the enhanced layers) other than the highest resolution enhancement layer, according to a further preferred embodiment of the invention the apparatus is capable of checking the available system resources. The result then will be taken into account in such a way that only those compression formats delivering an appropriate resolution will be selected. Thereby, less read-out data rate will be occupied and less resources such as power, spindle speed (noise factor) and others, are claimed. Other system resources such as remaining battery power, processor speed, or the like can be considered as well.

The above and other objects, features and advantages of the present invention will become apparent from the following description of preferred embodiments thereof taken in conjunction with the accompanying drawings in which:

FIG. 1 shows an example of a state of the art layered compression format encoding system;

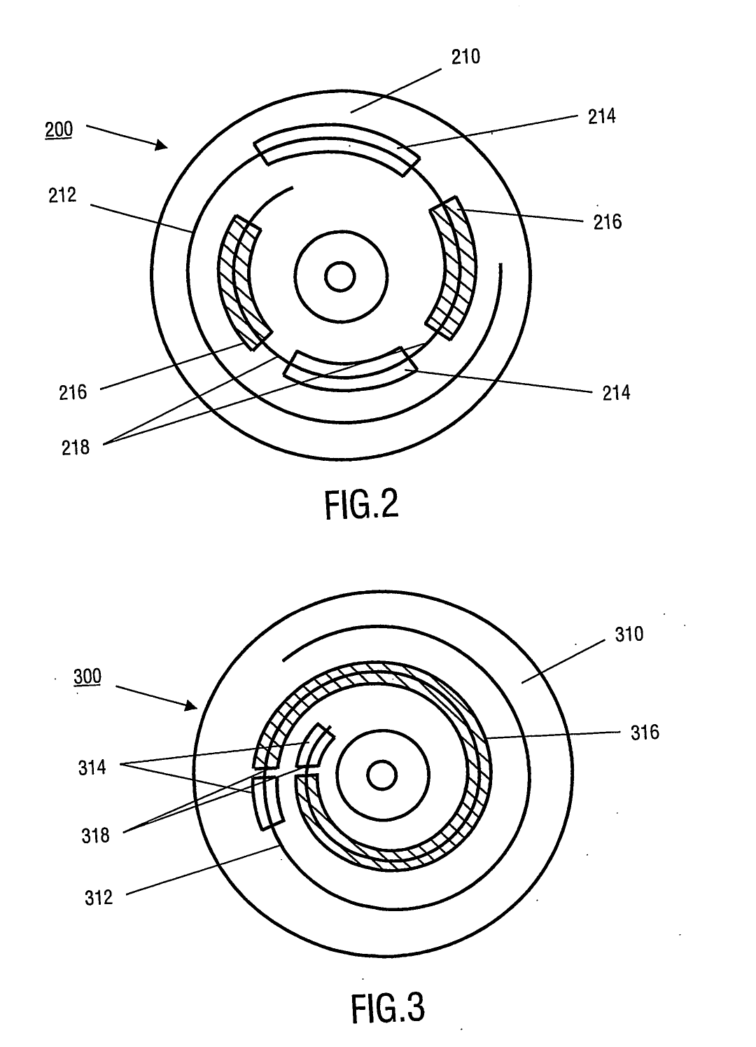

FIG. 2 shows a schematic view of a first example of a layered disc; and

FIG. 3 shows a schematic view of a second example of a layered disc.

A track 212 within the data zone 210 of an optical disc 200 as shown in FIG. 2 comprises two layers having different compression formats: a base layer 214 and an enhanced layer 216. These layers are arranged in an alternating order. It should be made sure that the data relating to the various layers of the layered stream are organized such that a skipping part of the stream to gain bandwidth in the end does not result in a loss of bandwidth because of the overhead caused by the jumps. Examples of measures to avoid this are:
1. Organizing data belonging to one layer in contiguous blocks, as depicted in FIG. 2 and FIG. 3. The larger the blocks, the less the penalty, but at the expense of other performance as reaction speed of the apparatus and memory buffer requirements. An optimum has to be found.
2. Making sure that a contiguous block covers an integer amounts of disc rotations, plus a small slip distance 318, such that jumping over a block of the play-back head can be done without requiring an idle full rotation of the disc, see FIG. 3.

It is to be noted, that the present invention is not restricted to the above preferred embodiments and examples. For example, other options of encoding may be applied, such as:
1. One base layer containing standard definition MPEG2 data (DVD quality) at Xₘₐₓ=10 Mbit/s, Xₐᵥ 4.5 Mbit/s, and one MPEG 2 enhancement layer, which, in combination with the base layer results in high definition data at Xₘₐₓ=24 Mbit/s;
2. One base layer containing standard definition MPEG2 data (DVD quality) at Xₘₐₓ=10 Mbit/s, Xₐᵥ 4.5 Mbit/s, and one enhancement layer containing more advanced decoder data (e.g. H264) decreasing the maximum bit rate or allowing higher quality video using the same bit rate (esp. for 60 Hz interlaced sports as in published compilations of Olympics etc.);
3. One base layer and a first enhancement layer according to one of the above examples, and a second enhancement layer containing further data above 24 Mbit/s to enhance top quality high definition video (esp for 60 Hz interlaced sports);
4. One base layer containing CIF quality MPEG2 data at Xₘₐₓ=4 Mbit/s, Xₐᵥ=1−2 Mbit/s, and first and second enhancement layer according to the first example;
5. Also, more intermediate layers can be added;
6. All layers (including base layers) can be based on novel coding techniques such as H264.

Furthermore, the invention is not restricted to a specific optical system such as DVD or BD, but relates to all storage media with random access properties and data-rate limitations. This also includes Hard Disk Drives, Magneto-optical disk systems, Flash Memories, and the like. The bit rates are not limited to those mentioned in the above examples and embodiments of the invention. The above examples were restricted to 1× read-out devices. However, the maximum read-out data rate supported by the drive depends on two factors, the maximum data rate at single speed (1×) defined in the system's standard (CD, DVD, BD, etc.) and a multiplier of the single speed data rate (e.g. 2×, 4×, 8×, etc.). Hence, if the drive supports higher read-out data rates (e.g. because it is a 2× version) this will be accounted for automatically.

1. An apparatus for streaming real time data from a storage medium containing layered coding formats, the apparatus comprising:
a selection means, and
a data readout device;
the selection means being arranged to receive from one or more applications commands initiating at least two data streams and indicating a demanded resolution, to retrieve information regarding coding formats available on said storage medium and regarding maximum read-out data rate supported by the data readout device, to select a compression format for each data stream on the basis of said received initiating commands, and said retrieved coding format information, so that the sum of data streams does not exceed said maximum read-out data rate, and to send a streaming request corresponding to said selected compression formats; and
the data readout device being arranged to receive said streaming request from said selection means, to read out data from said storage medium and to output corresponding data streams according to said request.

2. An apparatus according to claim 1,
characterized in that said selection means is arranged to access a predetermined priority information of said applications and selects said compression format further according to said predetermined priority information.

3. An apparatus according to claim 1,
characterized in that said selection means is arranged to interpret a tag carried by each of said initiating commands indicating a level of priority and selects said compression format further according to said level of priority.

4. An apparatus according to claim 1,
characterized in that said selection means is arranged to check available system resources and to select said compression format further taking into account said system resources.

5. An apparatus according to claim 1,
characterized in that said selection means comprises means arranged to reduce said maximum read out data rate by a value taking into account a processing time said data readout device requires for switching between the accesses to said at least two data streams, and to provide the result for said selection.

6. Method for streaming real time data from a storage medium containing layered coding formats, the method comprising the steps:
receiving from one or more applications commands initiating at least two data streams and indicating a demanded resolution;
retrieving information regarding coding formats available on said storage medium and regarding maximum read-out data rate supported by a data readout device;
selecting a compression format for each data stream on the basis of said received commands, and said retrieved coding format information, so that the sum of data streams does not exceed said maximum read-out data rate; and
sending streaming requests corresponding to said selected compression formats to said data readout device.

7. Method according to claim 6,
characterized in that said selection is executed according to a predetermined priority of said applications.

8. Method according to claim 6,
characterized in that each of said initiating commands carries a tag indicating a level of priority and said selection is executed according to said level of priority indicated by said tag.

9. Method according to claim 6,
characterized in that it comprises the step checking available system resources and said selection further takes into account said system resources.

10. Method according to claim 6,
characterized in that it comprises the steps reducing said maximum read out data rate by a value taking into account a processing time said data readout device requires for switching between the accesses to said at least two data streams, and providing the result for said selection.
